(19) United States
(12) Patent Application Publication
(10) Pub. No.: US 2022/0277713 A1
(43) Pub. Date: Sep. 1, 2022

(54) SOUND PRODUCTION CONTROL APPARATUS, KEYBOARD MUSICAL INSTRUMENT, AND SOUND PRODUCTION CONTROL METHOD

(71) Applicant: YAMAHA CORPORATION, Hamamatsu-shi (JP)

(72) Inventors: Daisuke MIURA, Hamamatsu-shi (JP); Masahiro KAKISHITA, Hamamatsu-shi (JP); Kenichi NISHIDA, Hamamatsu-shi (JP); Shinichi ITO, Hamamatsu-shi (JP); Akihiro SUGISHIMA, Hamamatsu-shi (JP); Shinichi OHTA, Hamamatsu-shi (JP); Tsuyoshi SATO, Hamamatsu-shi (JP); Yasuhiko OBA, Hamamatsu-shi (JP); Jun ISHII, Hamamatsu-shi (JP)

(21) Appl. No.: 17/747,120

(22) Filed: May 18, 2022

Related U.S. Application Data
(63) Continuation of application No. PCT/JP2020/042936, filed on Nov. 18, 2020.

(30) Foreign Application Priority Data
Nov. 20, 2019 (JP) 2019-209664

(51) Int. Cl. G10H 1/00; G10H 1/34; G10H 1/44; G10H 1/053

(52) U.S. Cl. CPC G10H 1/0008; G10H 1/344; G10H 1/44; G10H 1/053; G10H 2220/221; G10H 2220/265

(57) ABSTRACT

A sound production control apparatus has a position detector that detects, in accordance with a playing operation of a musical instrument, a position of a key displaceable within a movement range from a start position to an end position. The movement range includes a sounding range including a sounding position and a setting range that is closer to the start position than the sounding range. The apparatus causes a played sound associated with the key to be produced upon the detected position of the key reaching the sounding position, while controlling a characteristic of the played sound depending on a displacement characteristic of the key within the setting range before the key is positioned in the sounding range.

### CROSS REFERENCE TO RELATED APPLICATIONS

This application is a Continuation Application of PCT Application No. PCT/JP2020/042936, filed on Nov. 18, 2020, and is based on and claims priority from Japanese Patent Application No. 2019-209664, filed on Nov. 20, 2019, the entire contents of each of which are incorporated herein by reference.

### BACKGROUND

### Technical Field

The present disclosure relates to a technology for controlling sound production responsive to operation of a plurality of keys.

### Background Information

Various technologies have been proposed to control characteristics of a played sound produced responsive to depression of a key or other playing operations of musical instruments. For example, Japanese Patent Application Laid-Open Publication No. 2009-150936 (hereinafter, JP 2009-150936) discloses a configuration for controlling a velocity of a music sound depending on a close proximity to or separation of a player's finger from a surface of a key.

However, in the configuration of JP 2009-150936, a sensor for detecting a close proximity to or separation of the player's finger from a surface of a key must be installed separately from a sensor for detecting a playing operation.

### SUMMARY

In consideration of the above circumstances, an object according to an aspect of the present disclosure is to produce by use of a simple configuration a played sound responsive to a playing operation of a musical instrument.

In order to solve the above problem, a sound production control apparatus according to one aspect of the present disclosure is a sound production control apparatus for a keyboard musical instrument including a key and includes a position detector configured to detect, in accordance with a playing operation of the key, a position of the key that is displaceable within a movement range from a start position to an end position, the movement range including: a sounding range including a sounding position; and a setting range that is closer to the start position than the sounding range; one or more memories for storing instructions; and one or more processors communicatively connected to the one or more memories that execute the stored instructions to cause a played sound associated with the key to be produced upon the detected position of the key reaching the sounding position, while controlling a characteristic of the played sound depending on a displacement characteristic of the key within the setting range before the key is positioned in the sounding range.

A keyboard musical instrument according to one aspect of the present disclosure includes a music keyboard including a key displaceable within a movement range from a start position to an end position responsive to a playing operation, the movement range including: a sounding range including a sounding position; and a setting range that is closer to the start position than the sounding range; a position detector configured to detect a position of the key within the movement range; one or more memories for storing instructions; and one or more processors communicatively connected to the one or more memories that execute the stored instructions to cause a played sound associated with the key to be produced upon the detected position of the key reaching the sounding position, while controlling a characteristic of the played sound depending on a displacement characteristic of the key within the setting range before the key is positioned in the sounding range.

A sound production control method according to one aspect of the present disclosure is implemented by a computer of a sound production apparatus including a keyboard with a key that is displaceable within a movement range from a start position and an end position, and a position detector that detects, in accordance with a playing operation of the key, a position of the key, the movement range including a sounding range that includes a sounding position and a setting range that is closer to the start position than the sounding range, the method including: obtaining the detected position of the key from the position detector; and causing a played sound associated with the key to be produced upon the detected position of the key reaching the sounding position, while controlling a characteristic of the played sound depending on a displacement characteristic of the key within the setting range before the key is positioned in the sounding range.

### BRIEF DESCRIPTION OF THE DRAWINGS

FIG. 1 is a block diagram showing an example configuration of a keyboard musical instrument in a first embodiment.

FIG. 2 is an explanatory diagram regarding displacement of each key.

FIG. 3 is an explanatory diagram regarding displacement of each key.

FIG. 4 is a schematic diagram of a table for identifying a sound production characteristic from a displacement characteristic.

FIG. 5 is a flowchart illustrating an example procedure of sound production control processing.

FIG. 6 is an explanatory diagram showing sound production characteristics in the second embodiment.

### DESCRIPTION OF THE EMBODIMENTS

### A: First Embodiment

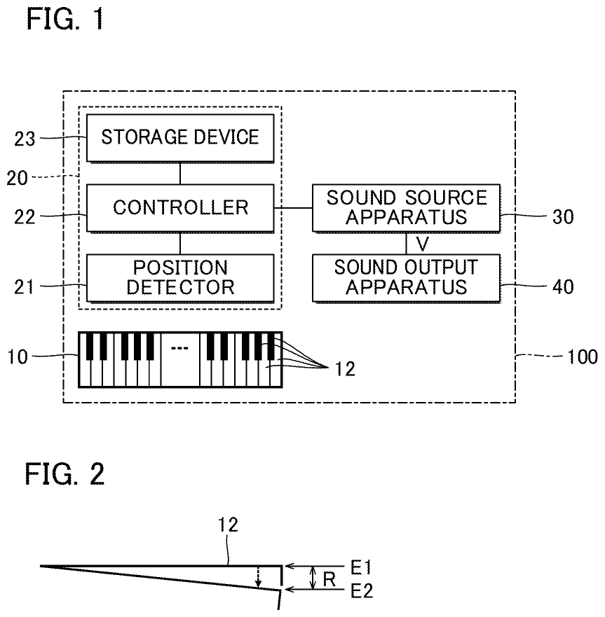

FIG. 1 is a block diagram illustrating a keyboard musical instrument 100 according to a first embodiment of the present disclosure. The keyboard musical instrument 100 is an electronic musical instrument that produces a sound (hereafter, “played sound”) responsive to playing by a player. The keyboard musical instrument 100 includes a music keyboard 10, a sound production control apparatus 20, a sound source apparatus 30, and a sound output apparatus 40.

The music keyboard 10 comprises a plurality of keys 12 each of which corresponds to a different pitch. The plurality of keys 12 is arranged in a transverse direction relative to a player and includes both white keys and black keys. FIG. 2 is a side view focusing on any one of the plurality of keys 12. As shown in FIG. 2, a key 12 is displaced in a vertical direction within a movement range R responsive to a playing operation by the player. The movement range R is a range between a start position E1 and an end position E2. The start position E1 is the upper end of the movement range R, and the end position E2 is the lower end of the movement range R. The start position E1 is the upper surface position of a key 12 in a released state when the player's finger is not in contact with the key 12. The end position E2 is the upper surface position of the key 12 in a depressed state when the player's finger is in contact with and fully depresses the key 12. As will be understood from the above explanation, responsive to depression of a key 12 in a released state, a position Z of the key 12 descends over time starting from the start position E1 and stops when it reaches the end position E2. Responsive to release of the key 12 in a depressed state, a position Z of the key 12 rises over time starting from the end position E2 and stops when it reaches the start position E1. As described above, each of the plurality of keys 12 is displaced within the movement range R from the start position E1 to the end position E2 responsive to a playing operation of the keyboard musical instrument 100.

The sound source apparatus 30 in FIG. 1 generates an audio signal V representative of a waveform of a played sound responsive to a playing operation by a player. Specifically, the audio signal V representing the played sound of a pitch that corresponds to a key 12 depressed by the player is generated. The sound output apparatus 40 outputs the played sound represented by the audio signal V. For example, a loudspeaker or headphones can be used as the sound output apparatus 40.

The sound production control apparatus 20 is a computer system that detects a position Z within the movement range R for each of the plurality of keys 12 and controls the sound source apparatus 30 in accordance with a position Z of a key 12. The sound production control apparatus 20 has a position detector 21, a controller 22, and a storage device 23.

The position detector 21 detects a position Z within the movement range R for each of the plurality of keys 12. For example, the position detector 21 is a magnetic sensor that utilizes a change in a magnetic field associated with a position Z of a key 12 to detect the position Z. As an example of a magnetic sensor, the contents of U.S. Patent Application Publication No. 2021/0151020, published May 20, 2021, is incorporated herein by reference. The position detector 21 may be an optical sensor that utilizes a change in an amount of received light associated with a position Z of the key 12 to detect the position Z (e.g., an optical sensor as described in U.S. Pat. No. 7,411,124, granted Aug. 12, 2008). The configuration and method of the position detector 21 for detection of a position Z of a key 12 is not limited to the above examples.

The controller 22 in FIG. 1 comprises one or more processors that control each element of the keyboard musical instrument 100. For example, the controller 22 comprises one or more of types of a Central Processing Unit (CPU), a Sound Processing Unit (SPU), a Digital Signal Processor (DSP), a Field Programmable Gate Array (FPGA), or Application Specific Integrated Circuit (ASIC).

The storage device 23 comprises either a single or multiple memories that store programs for execution by the controller 22 and data for use by the controller 22. For example, a time series of the positions Z detected for each key 12 by the position detector 21 is stored in the storage device 23 for each key 12. The storage device 23 comprises a known recording medium, such as a magnetic recording medium or semiconductor recording medium, for example. The storage device 23 may comprise a combination of multiple types of storage media. In addition, the storage device 23 may comprise a portable recording medium that is detachable from the keyboard musical instrument 100, or an external recording medium with which the keyboard musical instrument 100 is communicable (e.g., online storage). The controller 22 may realize the functions of the sound source apparatus 30 by execution of a program stored in the storage device 23. In other words, the sound source apparatus 30 dedicated to generation of audio signals V may be omitted.

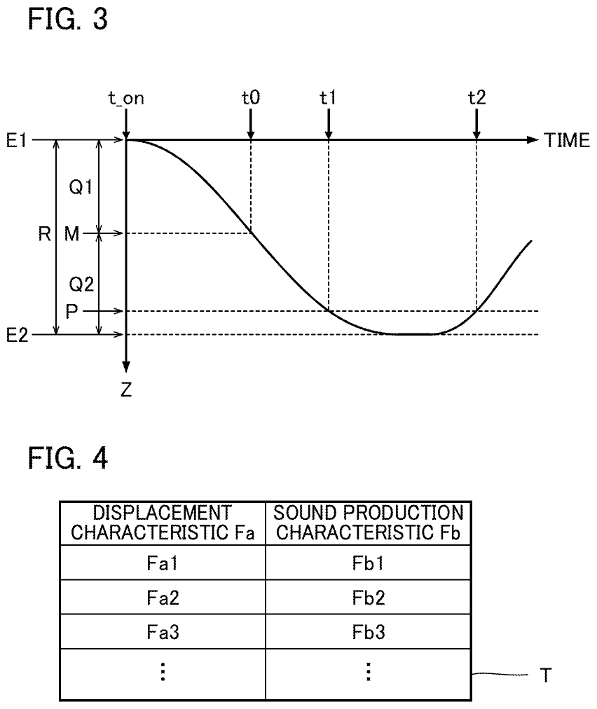

FIG. 3 is a graph showing a change in position Z detected by the position detector 21 for any one of keys 12 over time. Specifically, FIG. 3 shows a temporal change in position Z of a key 12 at a point t_on on the time axis when the player starts to depress the key 12. The position Z detected by the position detector 21 of the first embodiment for each key 12 is a continuous value representative of a point within the movement range R between and including the start position E1 and the end position E2.

The movement range R includes a setting range Q1 and a sounding range Q2. The setting range Q1 and the sounding range Q2 each constitute a part of the movement range R. The setting range Q1 is a range closer to the start position E1 than the sounding range Q2. The sounding range Q2 is a range closer to the end position E2 than the setting range Q1. Given a point M in the movement range R, the setting range Q1 is a range between the start position E1 and the point M; and the sounding range Q2 is a range between the point M and the end position E2. In other words, the point M corresponds to a boundary between the setting range Q1 and the sounding range Q2. The width of the setting range Q1 and that of the sounding range Q2 may be freely selected. Thus, the setting range Q1 may be wider than the sounding range Q2, and the setting range Q1 may be narrower than the sounding range Q2, or the setting range Q1 and sounding range Q2 may have the same width.

A sounding position P is set within the sounding range Q2. The sounding position P is a specific position within the sounding range Q2. In FIG. 3, a position near the end position E2 is shown as an example of the sounding position P. However, an upper end or a lower end (the end position E2) of the sounding range Q2 may be set as the sounding position P.

The controller 22 executes a program stored in the storage device 23, to serve as an element (sound production controller) for controlling the sound source apparatus 30. Specifically, the controller 22 instructs the sound source apparatus 30 to produce or mute a played sound in accordance with a position Z of a key 12 detected by the position detector 21. For example, responsive to a position Z of a key 12 reaching the sounding position P in the sounding range Q2 from the direction of the start position E1 (i.e., a key depression), the controller 22 instructs the sound source apparatus 30 to produce a played sound corresponding to the key 12. In other words, the controller 22 instructs the sound source apparatus 30 to produce a played sound at time t1 at which the position Z reaches the sounding position P from the direction of the start position E1. Further, responsive to the position Z of the key 12 reaching the sounding position P from the direction of the end position E2 in the sounding range Q2 (i.e., a key release), the controller 22 instructs the sound source apparatus 30 to mute a played sound corresponding to the key 12. In other words, the controller 22 instructs the sound source apparatus 30 to mute a played sound at time t2 at which the position Z reaches the sounding position P from the direction of the end position E2. As will be understood from the above description, the controller 22 produces or mutes a played sound corresponding to the key 12 depending on the position Z of the key 12 within the sounding range Q2. Specifically, the controller 22 causes the played sound to be produced or muted in response to the position Z of the key 12 reaching the sounding position P.

In addition to the sound production/mute control described above, the controller 22 controls a characteristic Fb of a played sound corresponding to a key 12 (hereafter, “sound production characteristic”) in accordance with a characteristic Fa of a temporal change in the position Z of key 12 within the setting range Q1 (hereafter, “displacement characteristic”). The displacement characteristic Fa is, for example, a pattern of changes in position Z over time (i.e., a time series of positions Z), a velocity of the key 12, which is a rate of change of the position Z, or an acceleration, which is a rate of change of the velocity of the key 12. The velocity as the displacement characteristic Fa may be a representative value (e.g., an average value) of the velocities within the setting range Q1, or a temporal pattern of change in velocity within the setting range Q1, for example. Similarly, the acceleration used as the displacement characteristic Fa may be a representative value (e.g., an average value) of accelerations within the setting range Q1 or a temporal pattern of change in acceleration within the setting range Q1, for example.

The sound production characteristics Fb of a played sound are acoustic characteristics of the played sound. The sound production characteristics Fb are, for example, characteristics related to a playing technique (playing method) of the played sound. For example, one of the following is selectively indicated to the sound source apparatus 30 as a sound production characteristic Fb: a sound to be played using a normal playing technique, a sound to be played using staccato to produce a short note, or a sound to be played using legato to produce a continuous sound. For example, assuming that a velocity or acceleration of a key 12 is used as a displacement characteristic Fa, the controller 22 indicates a sound to be played using a normal playing technique responsive to a numerical value of the displacement characteristic Fa falling within a predetermined range (hereafter, “reference range”). On the other hand, responsive to the numerical value of the displacement characteristic Fa exceeding a maximum value of the reference range, the controller 22 indicates a sound to be played using staccato, and responsive to a numerical value of the displacement characteristic Fa being below the minimum value of the reference range, the controller 22 indicates a sound to be played using legato.

The table T shown in FIG. 4 is stored in the storage device 23 and is used to identify a sound production characteristic Fb in accordance with a displacement characteristic Fa. The table T is a data table in which a plurality of displacement characteristics Fa (Fa1, Fa2, . . . ) and a plurality of sound production characteristics Fb (Fb1, Fb2, . . . ) are correlated. The controller 22 generates a displacement characteristic Fa within the setting range Q1 from a time series of the positions Z for a key 12 detected by the position detector 21, and retrieves from the table T a sound production characteristic Fb that corresponds to the displacement characteristic Fa. Then, the controller 22 indicates to the sound source apparatus 30 the sound production characteristic Fb retrieved from the table T. For example, at time t0 when the position Z of the key 12 reaches the lower end of the setting range Q1 (i.e., the point M), the controller 22 identifies and indicates the sound production characteristic Fb.

A case is assumed in which a continuous playing operation causes a key 12 to continuously move from the start position E1 to the end position E2. The controller 22 first indicates to the sound source apparatus 30 a sound production characteristic Fb in accordance with a displacement characteristic Fa within the setting range Q1. Then, following the indication of the sound production characteristic Fb of the played sound, the controller 22 instructs sounding of the played sound at time t1 at which the position Z of the key 12 reaches the sounding position P. As will be understood from the above description, a sound production characteristic Fb is set separately for each key 12 in accordance with a displacement characteristic Fa of a key 12 for each of the plurality of played sounds corresponding to different keys 12.

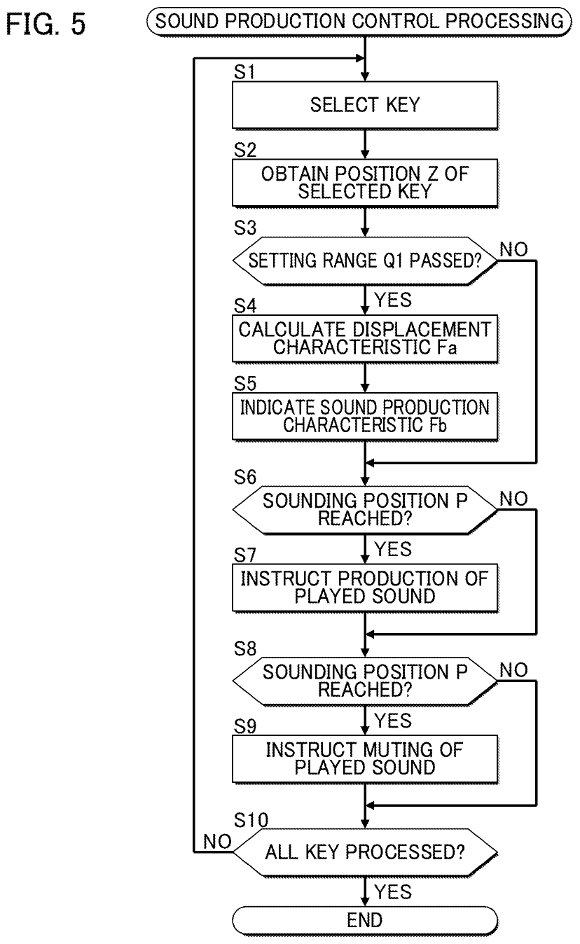

FIG. 5 is a flowchart illustrating an example procedure of processing by which the controller 22 controls the sound source apparatus 30 in accordance with a position Z of each key 12 (hereafter, “sound control processing”). For example, the sound control processing is repeated at intervals that are of a sufficiently short length of time for a position Z of a key 12 to change responsive to depression of the key 12.

When the sound control processing starts, the controller 22 selects one of the plurality of keys 12 (hereafter, “selected key 12”) (S1). The controller 22 obtains a position Z of the selected key 12 from the position detector 21 (S2), and determines whether the position Z has passed through the setting range Q1 (S3). In other words, it is determined whether the position Z has reached the point M from the direction of the start position E1.

If the position Z of the selected key 12 has passed through the setting range Q1 (S3: YES), the controller 22 calculates a displacement characteristic Fa of the selected key 12 within the setting range Q1 (S4). The controller 22 indicates to the sound source apparatus 30 a sound production characteristic Fb that corresponds to the calculated displacement characteristic Fa in the table T (S5). If the position Z of the selected key 12 has not passed through the setting range Q1 (S3: NO), the calculation of a displacement characteristic Fa (S4) and the indication of a sound production characteristic Fb (S5) are not executed.

The controller 22 determines whether the position Z of the selected key 12 has reached the sounding position P from the direction of the start position E1 (S6). If the position Z of the selected key 12 has reached the sounding position P from the direction of the start position E1 (S6: YES), the controller 22 instructs the sound source apparatus 30 to produce a played sound that corresponds to the selected key 12 (S7). The sound source apparatus 30, which is instructed to produce the played sound, generates an audio signal V representing the played sound with the sound production characteristic Fb indicated immediately previously for the selected key 12. In response to supply of the audio signal V to the sound output device 40, the sound output device 30 outputs a played sound with the sound production characteristic Fb determined based on a displacement of the selected key 12 within the setting range Q1. If the position Z has not reached the sounding position P from the direction of the start position E1 (S6: NO), the instruction (S7) for producing the played sound is not executed.

The controller 22 determines whether the position Z of the selected key 12 has reached the sounding position P from the direction of the end position E2 (S8). If the position Z of the selected key 12 has reached the sounding position P from the direction of the end position E2 (S8: YES), the controller 22 instructs the sound source apparatus 30 to mute the played sound corresponding to the selected key 12 (S9). The sound source apparatus 30, which has been instructed to mute the played sound, stops generating the audio signal V representing the played sound. Consequently, the played sound corresponding to the selected key 12 stops sounding.

The controller 22 determines whether the above processes have been executed for all the keys 12 (S10). If there is a key 12 that has not been processed (S10: NO), the controller 22 selects the unselected key 12 (S1) and executes the processes (S2 to S10) described above for the selected key 12. When all the keys 12 have been processed (S10: YES), the controller 22 ends the sound control processing.

As described above, in the first embodiment, a played sound is produced in accordance with a position Z of a key 12 within the sounding range Q2, which is within the movement range R of the key 12. Further, a sound production characteristic Fb of a played sound is controlled in accordance with a temporal change in a position Z of the key 12 within the setting range Q1 that is within the movement range R and that is closer to the start position E1 than the sounding range Q2. In other words, the position detector 21 that detects the position Z of the key 12 within the movement range R is used both for production of the played sound and for control of the sound production characteristic Fb of the played sound. Therefore, it is possible to produce the played sound in accordance with a playing operation by use of a simple configuration.

Further, the sound production characteristic Fb of the played sound and the production of the played sound are controlled by a continuous playing operation to move a key 12 from the setting range Q1 to the sounding range Q2 (sounding position P). In other words, the sound production characteristic Fb is controlled in accordance with a change in the position Z of a key 12 within the setting range Q1, and the production of the played sound is controlled in accordance with the position Z of the key 12 within the sounding range Q2 into which the key 12 moves immediately subsequently from the setting range Q1. According to the above configuration, there is no need for a player to perform two separate operations to specify a sound production characteristic Fb and instruct the production of a played sound. In other words, with a continuous playing operation by which a key 12 is moved within the movement range R, a sound production characteristic Fb is indicated and a played sound is produced. Accordingly, an advantage is obtained by enabling the sounding of a played sound with various sound production characteristics Fb while reducing a burden on the player.

### B: Second Embodiment

The first embodiment describes the sound production characteristics of the played sound Fb relative to a playing technique. The sound production characteristics Fb in the second embodiment are the characteristics of an Attack section in a played sound. In the following embodiments, for elements whose functions are substantially the same as those of the first embodiment like reference signs are used, and detailed description thereof is omitted as appropriate.

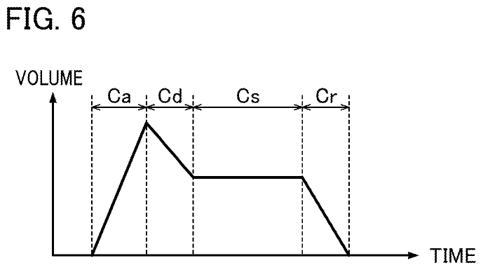

FIG. 6 is an explanatory diagram showing sound production characteristics Fb in the second embodiment. A produced played sound includes an Attack section Ca, which corresponds to a rise of the played sound. The sound production characteristic Fb in the second embodiment is a characteristic of the Attack section Ca in the played sound. For example, the sound production characteristic Fb is a time length of the Attack section Ca (attack time) or a volume at the end of the Attack section Ca (attack level). A rate of change in a volume in the Attack section Ca may be also used as a sound production characteristic Fb.

As explained above, the controller 22 of the second embodiment controls the sound production characteristic Fb of the Attack section Ca in the played sound. For example, given that a velocity or acceleration of the key 12 is the displacement characteristic Fa, the controller 22 controls the sound source apparatus 30 such that the larger the numerical value of the displacement characteristic Fa, the larger or smaller the numerical value of the sound production characteristic Fb. The configuration and operation other than the content of the sound production characteristics Fb are the same as those in the first embodiment. Therefore, in the second embodiment, the same effects as in the first embodiment are realized.

In the above description, the sound production characteristic Fb in the Attack section Ca is used as an example. However, a characteristic of a section other than the Attack section Ca in the played sound can also be used as the sound production characteristic Fb. For example, a time length or volume of a Sustain section Cs, where a volume is maintained at a steady level, may be used as the sound production characteristic Fb. Further, a time length of a Decay section Cd between the Attack section Ca and the Sustain section Cs, or a time length of a Release section Cr during which a volume of a played sound decays immediately after the Sustain section Cs, may be used as the sound production characteristic Fb. A rate of change in a volume in the Release section Cr may also be used as the sound production characteristic Fb.

### C: Third Embodiment

The controller 22 in the third embodiment controls a volume of a played sound in accordance with the displacement characteristic Fa of a key 12 within the setting range Q1. In other words, a volume of a played sound is the sound production characteristic Fb that the controller 22 indicates to the sound source apparatus 30. For example, if the velocity or acceleration of the key 12 is the displacement characteristic Fa, the controller 22 controls the sound source apparatus 30 such that the greater the numerical value of the displacement characteristic Fa, the louder the volume of the played sound. The configuration and operation other than the content of the sound production characteristic Fb are the same as those in the first embodiment. Therefore, in the third embodiment, the same effects as those in the first embodiment are realized.

### D: Modifications

The following are example modifications that may be added to each of the above embodiments. Two or more modes freely selected from the following examples may be combined as appropriate to the extent that they do not contradict each other.

(1) The sound production characteristics Fb of a played sound controlled in accordance with the displacement characteristics Fa within the setting range Q1 are not limited to the above examples (playing technique, characteristics of a respective section of the played sound, and volume of the played sound). For example, a presence or absence of a playing technique (musical expression), such as a tie or slur, in the played sound may be controlled by the controller 22 in accordance with the displacement characteristic Fa.

(2) In the relevant embodiment described above, the sound production characteristic Fb of the played sound is controlled in accordance with the displacement characteristic Fa within the setting range Q1. However, the target of control based on the displacement characteristic Fa is not limited to the sound production characteristic Fb. Specifically, the controller 22 may control any setting (parameter) of the keyboard musical instrument 100 in accordance with the displacement characteristics Fa within the setting range Q1. In other words, the keys 12 used for the playing operation to produce the played sounds are used for controlling various settings related to the keyboard musical instrument 100.

Following are examples of settings that may be controlled in accordance with the displacement characteristics Fa. It is of note that as in the relevant embodiment described above, a played sound is produced in response to a position Z of a key 12 reaching the sounding position P. However, it is not necessary for the position Z of each key 12 to reach the sounding position P (i.e., it is not necessary for the played sound to be produced) in changing the settings of the keyboard musical instrument 100. In the following description, a numerical value such as that for a velocity or acceleration of a key 12 is assumed as a displacement characteristic Fa. Two or more modes selected from the following examples may be combined with each other.

### Mode 1

When a player plays a chord by depressing multiple keys 12 simultaneously, the chord of a played sound may be controlled by the controller 22 in accordance with the displacement characteristic Fa within the setting range Q1. For example, when the numerical value of the displacement characteristic Fa is within a reference range, the controller 22 indicates to the sound source apparatus 30 a played sound of the chord played by the player. On the other hand, when the numerical value of the displacement characteristic Fa exceeds the reference range, the controller 22 indicates to the sound source apparatus 30 a played sound of a tension chord corresponding to the chord played by the player. When the value of the displacement characteristic Fa is below the reference range, the controller 22 indicates to the sound source apparatus 30 a played sound of a power chord corresponding to the chord played by the player. The controller 22 may also control a chord type of the played sound in accordance with the displacement characteristics Fa. For example, the controller 22 may set the chord of the played sound as a major chord or a minor chord in accordance with the displacement characteristic Fa.

### Mode 2

Assumed is a keyboard musical instrument 100 that automatically plays a specific part of a piece of music (hereafter, a “specific part”). The specific part is, for example, an accompaniment part of a piece of music. The controller 22 may control the settings related to the specific part in accordance with a displacement characteristic Fa within the setting range Q1. For example, a tempo of the specific part, a rhythm pattern of the specific part, a type of musical instrument used to play the specific part, or a performance style of the specific part are controlled in accordance with the displacement characteristic Fa. More specifically, the tempo of the specific part may increase as the numerical value of the displacement characteristic Fa increases, or the specific part may be changed to a play part that has a clearly defined rhythm as the numerical value of the displacement characteristic Fa increases. When the player periodically varies the position Z of a key 12 within the setting range Q1, the controller 22 may control the keyboard musical instrument 100 such that the automatic playing of the specific part is performed at a tempo corresponding to a period of a variation.

### Mode 3

The periodic variation of the played sound may be controlled in accordance with a displacement characteristic Fa within the setting range Q1. The periodic variation of the played sound is, for example, vibrato in which a pitch of the played sound continuously varies, tremolo in which the played sound of one pitch is repeatedly produced, or trill in which a played sound of two different notes is alternately produced. When the player periodically varies the position Z of a key 12 within the setting range Q1, the controller 22 controls the sound source apparatus 30 such that the played sound varies periodically in a cycle corresponding to the variation (for example, a period equivalent to the variation). A depth of vibrato of the played sound may be controlled in accordance with the amplitude of the position Z.

### Mode 4

An external device may be connected to the keyboard musical instrument 100. The external device is, for example, a sound device that processes an audio signal V generated by the sound source apparatus 30. An effect-imparting device (effector) that imparts various effects to the audio signal V, an amplifier that amplifies the audio signal V, or a recording device that records the audio signal V are each examples of the sound device. The controller 22 may control various settings (parameters) of a sound device in accordance with a displacement characteristic Fa within the setting range Q1. Further, a communication device that transmits an audio signal V generated by the sound source apparatus 30 is an example of an external device connected to the keyboard musical instrument 100. The controller 22 can be used to control various settings of the communication device in accordance with displacement characteristics Fa within the setting range Q1. As will be understood from the above description, the displacement characteristics Fa within the setting range Q1 may be used not only for controlling settings related to the keyboard musical instrument 100, but may also be used for controlling settings related to devices other than the keyboard musical instrument 100.

(3) A player may be notified that the position Z of the key 12 has reached the point M within the movement range R. For example, a notification sound may be output from the sound output apparatus 40 when the position Z reaches the point M, or a light emitting element may be caused to emit light when the position Z reaches the point M. A display device may display an image to notify a player that the position Z has reached the point M. Further, a player may tactilely perceive that the position Z has reached the point M. For example, a key 12 may be caused to vibrate by vibration of a vibrating body responsive to the position Z reaching the point M. A projection with which a key 12 is in contact may be installed at the point M. The key 12 vibrates upon contact with the projection, whereby a player is able to perceive that the position Z has reached the point M.

(4) There may be stored in the storage device 23 a sound production characteristic Fb corresponding to a displacement characteristic Fa at a time of depression of a key 12, and the sound production characteristic Fb may be applied (i.e., reused) to produce a played sound responsive to a subsequent depression of the key. For example, responsive to a first depression of a key 12 after the player starts playing, a sound production characteristic Fb therefor is stored in the storage device 23 for the key 12. The sound production characteristic Fb at the time of the key depression the first time after the player instructs storage of the sound production characteristic Fb may be stored in the storage device 23. The sound production characteristic Fb stored in the storage device 23 for a key 12 may be reused for the production of a played sound when the key 12 is depressed. For example, the sound production characteristic Fb stored in the storage device 23 is reused for a length of time instructed by the player. The sound production characteristic Fb stored in the storage device 23 is reused for a number of key depressions instructed by the player. Further, for example, the sound production characteristic Fb stored in the storage device 23 may be deleted responsive to an instruction from the player. For example, the sound production characteristics Fb corresponding to all of the keys 12 may be deleted at once, or a sound production characteristic Fb corresponding to one of the keys 12 specified by the player may be selectively deleted.

It is of note that in the above description a sound production characteristic Fb is stored in the storage device 23. However, a displacement characteristic Fa, which is the basis of a sound production characteristic Fb, may be stored in the storage device 23. For example, a displacement characteristic Fa responsive to depression of a key 12 is stored in the storage device 23, and a sound production characteristic Fb corresponding to the displacement characteristic Fa is applied to the production of the played sound upon a next and subsequent depressions of the key 12.

(5) In the relevant embodiment described above, an example is given of a keyboard musical instrument 100 with a plurality of keys 12. However, a musical instrument to which the present disclosure is applied is not limited to keyboard musical instruments 100. For example, the present disclosure may also be applied to electronic wind instruments with a plurality of operators. Specifically, the sound production characteristic Fb of a played sound is controlled in accordance with the displacement characteristic Fa of each of the plurality of operators. As will be understood from the above examples, the present disclosure is applicable to musical instruments with operators that are displaced responsive to playing operations, and a key 12 in the foregoing embodiments is an example of an operator.

(6) In the relevant embodiment described above, a sound production characteristic Fb and the production of a played sound are indicated to the sound source apparatus 30 separately. However, the sound production characteristic Fb and the production of the played sound may be indicated to the sound source apparatus 30 together. For example, the controller 22 may transmit to the sound source apparatus 30 control data including the indication of a sound production characteristic Fb and the instruction for the production of the played sound.

(7) In the relevant embodiment described above, an example is given of a keyboard musical instrument 100 provided with a sound production control apparatus 20 and a sound source apparatus 30. However, the sound production control apparatus 20 and the sound source apparatus 30 may be configured as separate devices. For example, the sound production control apparatus 20 transmits control data instructing sounding/muting of a played sound or control data indicating a sound production characteristic Fb to the sound source apparatus 30 provided externally to the sound production control apparatus 20. The control data indicating sounding is, for example, a Musical Instrument Digital Interface (MIDI) (registered trademark) note-on message, and the control data indicating muting is, for example, a MIDI note-off message. The control data indicating the sound production characteristic Fb is, for example, a MIDI control message. The control data may be transmitted from the sound production control apparatus 20 to the sound source apparatus 30 using a known communication protocol, such as OpenSound Control.

As will be understood from the above description, the sound production controller is comprehensively expressed as an element that produces a played sound and controls a characteristic of a played sound. In addition to elements that control the sound source apparatus 30 that is integrally configured with the sound production control apparatus 20, the concept of the sound controller also encompasses elements that instruct an external device (e.g., the sound source apparatus 30) separate from the sound production control apparatus 20 to control the production or characteristics of played sounds.

(8) In the relevant embodiment described above, the movement range R is divided into a single setting range Q1 and a single sounding range Q2. However, the number of setting ranges Q1 or the number of sounding ranges Q2 included in the movement range R may be freely selected. For example, the movement range R may include two or more setting ranges Q1 or two or more sounding ranges Q2. For example, a sound production characteristic Fb is controlled in accordance with a displacement characteristic Fa within the respective setting range Q1 or the average of the displacement characteristics Fa over the multiple setting ranges Q1. Further, for the played sound, different types of sound production characteristics Fb corresponding to the respective sounding ranges Q2 may be controlled. Further, a range within the setting range Q1 or sounding range Q2 may be set freely.

(9) In the relevant embodiment described above, an example is given of a configuration in which the setting range Q1 and the sounding range Q2 are adjacent to each other. However, a predetermined gap may be left between the setting range Q1 and the sounding range Q2. Further, the setting range Q1 and the sounding range Q2 may overlap each other. Specifically, a part of the setting range Q1 adjacent to the end position E2 and a part of the sounding range Q2 adjacent to the start position E1 may overlap each other.

A sound production characteristic Fb may be controlled in accordance with a displacement characteristic Fa within an overlapping range where the setting range Q1 and the sounding range Q2 overlap each other. For example, the controller 22 (sound production controller) may control the sound production characteristics Fb for the respective sections in FIG. 6 (especially from the Decay section Cd to the Release section Cr) in accordance with the displacement characteristic Fa in the overlapping range. More specifically, a velocity v1 of a key 12 in a non-overlapping range other than the overlapping range within the setting range Q1 and a velocity v2 of the key 12 within the overlapping range are used as the displacement characteristic Fa. For example, a proportion between the velocity v1 and the velocity v2 is applicable as the displacement characteristic Fa. It is of note that the non-overlapping range is the range from the start position E1 to the overlapping range within the movement range R.

For example, when the velocity v2 within the overlapping range is greater than the velocity v1 within the non-overlapping range (v2>v1), the controller 22 sets the volume of the Sustain section Cs to a numerical value greater than a predetermined reference value. When the velocity v2 is smaller than the velocity v1 (v2<v1), the volume of the Sustain section Cs is set to a numerical value smaller than the reference value. It is of note that the volume of the Sustain section Cs may be controlled continuously or in gradations in accordance with the velocity v2.

Further, when the velocity v2 in the overlapping range is greater than the velocity v1 in the non-overlapping range (v2>v1), the controller 22 sets the time length of the Release section Cr to a numerical value shorter than a predetermined reference value; and when the velocity v2 is smaller than the velocity v1 (v2<v1), the controller 22 sets the time length of the Release section Cr to a value longer than the reference value. It is of note that the time length of the Release section Cr may be controlled continuously or in gradations in accordance with the velocity v2. Further, the time length of the Sustain section Cs may also be controlled in accordance with the velocity v2. In the above description, the sound production characteristic Fb is controlled in accordance with the displacement characteristics Fa within two ranges, namely, the overlapping range and the non-overlapping range that are within the setting range Q1. However, the number of ranges into which the setting range Q1 is divided and the way each range is set are not limited to the above examples.

(10) The above-exemplified functions are realized by coordination between one or more processors constituting the controller 22 and a program stored in the storage device 23. The program of the present disclosure can be provided in a form that is stored on a computer-readable recording media for installation in a computer. The recording medium is, for example, a non-transitory recording medium, and an optical recording medium (optical disc) such as a CD-ROM is a good example. However, any known form of recording media such as semiconductor recording media or magnetic recording media are also included. Non-transitory recording media include any recording media except transitory, propagating signals, but volatile recording media are not excluded. In a configuration where a distribution apparatus delivers the program via a communication network, the storage device 23 that stores the program in the distribution apparatus corresponds to the above-described non-transitory recording medium.

### E: Appendix

From the embodiments and modifications illustrated above, for example, the following configurations are derivable.

A sound production control apparatus in accordance with one aspect of the present disclosure (Aspect 1) includes a position detector configured to detect, in accordance with a playing operation of a musical instrument, a position (detected position) of a key that is displaced within a movement range from a start position to an end position; one or more memories for storing instructions; and one or more processors communicatively connected to the one or more memories that execute the stored instructions to: cause a played sound to be produced depending on the detected position of the key within a sounding range that is a part of the movement range. In causing the played sound to be produced, the one or more processors execute the stored instructions to control a characteristic of the played sound depending on a change in the detected position of the key within a setting range that is a part of the movement range and is closer to the start position than the sounding range. In the above aspect, a played sound is produced in accordance with a position of a key within the sounding range, which is a part of the movement range of the key, and a characteristic of a played sound is controlled in accordance with a change in position of the key within the setting range, which is closer to the start position than the sounding range of the movement range. In other words, the position detector that detects the position of a key within the movement range is used both for production of a played sound and control of characteristics of the played sound. Therefore, it is possible to produce a played sound in accordance with a playing operation by use of a simple configuration.

In an example (Aspect 2) of Aspect 1, in causing the played sound to be produced, the one or more processors execute the stored instructions to produce the played sound when the detected position of the key reaches a sounding position that is within the sounding range.

In an example (Aspect 3) of Aspect 1 or Aspect 2, in causing the played sound to be produced, the one or more processors execute the stored instructions, responsive to a movement of the position of the key from the setting range to the sounding range, to control, depending on a displacement of the key within the setting range, the characteristic of the played sound produced depending on the detected position of the key within the sounding range. In the above aspect, it is possible to control the characteristic of a played sound and the production of the played sound by a continuous playing operation in which a key is continuously moved from the setting range to the sounding range. Thus, the characteristic of the played sound is controlled in accordance with the displacement of the key within the setting range, and the production of the played sound is controlled in accordance with the position of the key within the sounding range into which the key moves immediately subsequently.

The characteristics of the played sound controlled may be freely selected and may be characteristics related to a playing technique of the played sound, characteristics of the Attack section in the played sound, or the volume of the played sound.

In one aspect of the present disclosure, a sound control method is implemented by a computer of a sound production apparatus provided with a position detector that detects in accordance with a playing operation of a musical instrument a position of a key that is displaced within a movement range from a start position to an end position, the method including: obtaining the detected position of the key from the position detector; and causing a played sound to be produced depending on the obtained detected position of the key within a sounding range that is a part of the movement range. The causing the played sound to be produced includes controlling a characteristic of the played sound depending on a change in the detected position of the key within a setting range that is a part of the movement range and is closer to the start position than the sounding range.

A program according to one aspect of the present disclosure is a program executable by a computer of a sound production control apparatus provided with a position detector that detects a position of a key that is displaced within a movement range from a start position to an end position responsive to a playing operation of a musical instrument, to execute a sound producing method including: obtaining the detected position of the key from the position detector; and causing a played sound to be produced depending on the obtained detected position of the key within a sounding range that is a part of the movement range. The causing the played sound to be produced includes controlling a characteristic of the played sound depending on a change in the detected position of the key within a setting range that is a part of the movement range and is closer to the start position than the sounding range.

### DESCRIPTION OF REFERENCE SIGNS

100 . . . keyboard musical instrument, 10 . . . music keyboard, 12 . . . keys, 20 . . . sound production control apparatus, 21 . . . position detector, 22 . . . controller, 23 . . . storage apparatus 30 . . . sound source apparatus 40 . . . sound output device.

What is claimed is:

1. A sound production control apparatus for a keyboard musical instrument including a key, the sound production control apparatus comprising:
a position detector configured to detect, in accordance with a playing operation of the key, a position of the key that is displaceable within a movement range from a start position to an end position, the movement range including:
a sounding range including a sounding position; and
a setting range that is closer to the start position than the sounding range;
one or more memories for storing instructions; and
one or more processors communicatively connected to the one or more memories that execute the stored instructions to cause a played sound associated with the key to be produced upon the detected position of the key reaching the sounding position, while controlling a characteristic of the played sound depending on a displacement characteristic of the key within the setting range before the key is positioned in the sounding range.

2. The sound production control apparatus according to claim 1, wherein the one or more processors, in causing the played sound to be produced, responsive to a movement of the position of the key from the setting range to the sounding range, control the characteristic of the played sound produced depending on the displacement characteristic.

3. The sound production control apparatus according to claim 1, wherein the one or more processors, in causing the played sound to be produced, further control a characteristic related to a playing technique of the played sound.

4. The sound production control apparatus according to claim 1, wherein the controlling of the characteristic of the played sound include controlling an attack section in the played sound.

5. The sound production control apparatus according to claim 1, wherein the controlling of the characteristic of the played sound include controlling a volume of the played sound.

6. A keyboard musical instrument comprising:
a music keyboard including a key displaceable within a movement range from a start position to an end position responsive to a playing operation, the movement range including:
a sounding range including a sounding position; and
a setting range that is closer to the start position than the sounding range;
a position detector configured to detect a position of the key within the movement range;
one or more memories for storing instructions; and
one or more processors communicatively connected to the one or more memories that execute the stored instructions to cause a played sound associated with the key to be produced upon the detected position of the key reaching the sounding position, while controlling a characteristic of the played sound depending on a displacement characteristic of the key within the setting range before the key is positioned in the sounding range.

7. The keyboard musical instrument according to claim 6, wherein the one or more processors, in causing the played sound to be produced, responsive to a movement of the position of the key from the setting range to the sounding range, control the characteristic of the played sound produced depending on the displacement characteristic.

8. The keyboard musical instrument according to claim 6, wherein the one or more processors, in causing the played sound to be produced, further control a characteristic related to a playing technique of the played sound.

9. The keyboard musical instrument according to claim 6, wherein the controlling of the characteristic of the played sound include controlling an attack section in the played sound.

10. The keyboard musical instrument according to claim 6, wherein the controlling of the characteristic of the played sound include controlling a volume of the played sound.

11. A sound production control method implemented by a computer of a sound production apparatus including a keyboard with a key that is displaceable within a movement range from a start position and an end position, and a position detector that detects, in accordance with a playing operation of the key, a position of the key, the movement range including a sounding range that includes a sounding position and a setting range that is closer to the start position than the sounding range, the method comprising:
obtaining the detected position of the key from the position detector; and
causing a played sound associated with the key to be produced upon the detected position of the key reaching the sounding position, while controlling a characteristic of the played sound depending on a displacement characteristic of the key within the setting range before the key is positioned in the sounding range.

12. The sound production control method according to claim 11, wherein the causing of the played sound to be produced, responsive to a movement of the position of the key from the setting range to the sounding range, controls the characteristic of the played sound produced depending on the displacement characteristic.

13. The sound production control method according to claim 11, wherein the causing of the played sound to be produced further controls a characteristic related to a playing technique of the played sound.

14. The sound production control method according to claim 11, wherein the controlling of the characteristic of the played sound controls an attack section in the played sound.

15. The sound production control method according to claim 11, wherein the controlling of the characteristic of the played sound controls a volume of the played sound.
